(19) United States
(12) Patent Application Publication
(10) Pub. No.: US 2002/0184412 A1
(43) Pub. Date: Dec. 5, 2002

(54) System and method for locating and aligning to framing bits

(76) Inventors: James Ray Stevens, Dallas, TX (US); Daniel J. Ernst, Carrollton, TX (US)

Correspondence Address: Jack D. Stone, Jr., CARR & STORM, L.L.P., 900 Jackson Street, 670 Founders Square, Dallas, TX, 75202, US

(21) Appl. No.: 09/872,549

(22) Filed: Jun. 2, 2001

(51) Int. Cl. G06F 3/00

(52) U.S. Cl. 710/30

(57) ABSTRACT

A system and method for framing bits wherein fifteen bits of a parallel bit stream are examined to identify a first repeating byte and, upon identification of a first repeating byte, a bit offset of the byte from a bit zero of the parallel bit stream is determined. The bits in the parallel bit stream are then shifted by the determined bit offset to generate a byte aligned parallel bit stream. Each byte of the byte aligned parallel bit stream is then examined to identify a second repeating byte and, upon identification of a second repeating byte, a byte offset of the second repeating byte from a byte zero of the parallel bit stream is determined, and the bytes in the parallel bit stream are shifted by the determined byte offset to generate a frame aligned parallel bit stream. The frame aligned parallel bit stream is then transmitted, and a frame pulse is generated to accompany the frame aligned parallel bit stream.

### BACKGROUND

It is well-know that electronic communications are commonly performed through the serial transmission of bits. Eight consecutive bits typically constitute a symbol, such as a byte or a word, and a number, such as 810, of consecutive bytes typically constitutes a frame of data. If it is known where a byte or frame begins within a stream of bits, then it is a relatively trivial matter to use a counter to mark where all subsequent bytes and frames are located and to, therefore, derive meaningful data from the stream of bits. It is not, however, immediately apparent from a stream of bits where any byte or frame begins.

A number of framing devices have been developed to identify where bytes and frames begin and are located, but such framing devices generally become unwieldy for high bit rates, such as 10 Gbit rates (OC 192) and higher. More specifically, conventional framing devices must typically be custom-built, and consume relatively large quantities of power, and/or require a relatively large number of logic gates. Conventional framing devices for high bit rates are, therefore, large, uneconomical, and difficult to even obtain.

Accordingly, a continuing search has been directed to the development of framing systems and methods that may be implemented using commercially available components, and that are more economical with respect to space requirements, power consumption, and cost.

### SUMMARY

In accordance with the present invention, a system and method for framing bits is disclosed wherein fifteen bits of a parallel bit stream are examined to identify a first repeating byte and, upon identification of a first repeating byte, a bit offset of the byte from a bit zero of the parallel bit stream is determined. The bits in the parallel bit stream are then shifted by the determined bit offset to generate a byte aligned parallel bit stream. Each byte of the byte aligned parallel bit stream is then examined to identify a second repeating byte and, upon identification of a second repeating byte, a byte offset of the second repeating byte from a byte zero of the parallel bit stream is determined, and the bytes in the parallel bit stream are shifted by the determined byte offset to generate a frame aligned parallel bit stream. The frame aligned parallel bit stream is then transmitted, and a frame pulse is generated to accompany the frame aligned parallel bit stream.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a high-level conceptual block diagram illustrating a framing system embodying features of the present invention;

FIG. 2 is a schematic diagram of a device configured for aligning bytes in accordance with the present invention; and

FIG. 3 is a schematic diagram of a device configured for aligning frames in accordance with the present invention; and

FIG. 4 is a flow chart illustrating control logic for framing bits and bytes in accordance the present invention.

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning timing, shift register operations, standards (e.g., the Synchronous Optical Network (SONET) Transport Systems, STS, and OC), and the like have been omitted inasmuch as such details are not considered necessary to obtain a complete understanding of the present invention, and are considered to be within the skills of persons of ordinary skill in the relevant art.

Unless indicated otherwise, all functions described herein are performed by a processor such as a computer or electronic data processor in accordance with code such as computer program code, software, and/or integrated circuits that are coded to perform such functions. Furthermore, bits are referred to herein as constituting bytes of 8 bits each, but may also constitute words of varying bit lengths, such as 16 bits. Therefore, all references made to bytes apply to words as well.

Reference is now made to the drawings wherein depicted elements are, for the sake of clarity, not necessarily shown to scale, and wherein like or similar elements are designated by the same reference numeral through the several views.

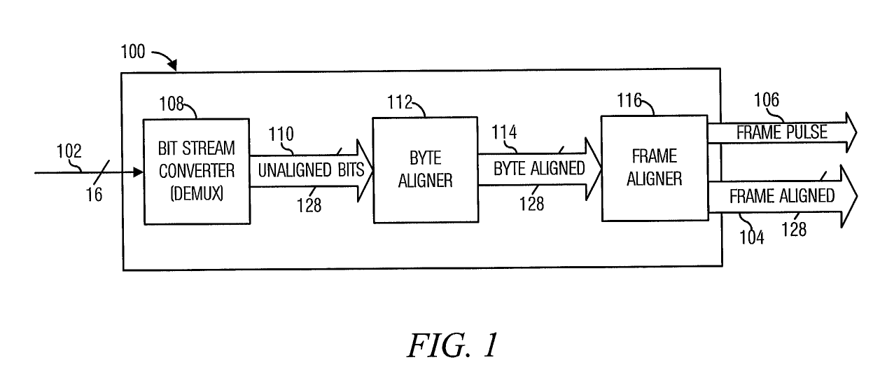

Referring to FIG. 1 of the drawings, the reference numeral 100 generally designates a framing system embodying features of the present invention for receiving a stream of unaligned bits on a line or bus 102, and for generating, from the unaligned bits, a frame-aligned bit stream on a bus 104 and a frame pulse on a line 106. The bit stream received on the bus 102 may be any number of bits wide, and represents frames of data. For the sake of illustration of the present invention, it is assumed herein that the bit stream on the bus 102 is 16 bits wide, and conforms to the OC 192 standard for framing. Furthermore, in accordance with OC 192, it is also understood that each the first 192 bytes of an OC 192 frame are F6 (hexadecimal), and the second 192 bytes of an OC 192 frame are 28 (hexadecimal).

The system 100 includes a conventional converter 108 configured for receiving a bit stream on a 16-bit wide parallel bus 102, and converting it to a 128 bit wide parallel bit stream. The 128 bit wide parallel bit stream is preferred for use with OC 192 and for purposes of illustration herein, but may be other widths also, such as 64 bits wide, or 256 bits wide.

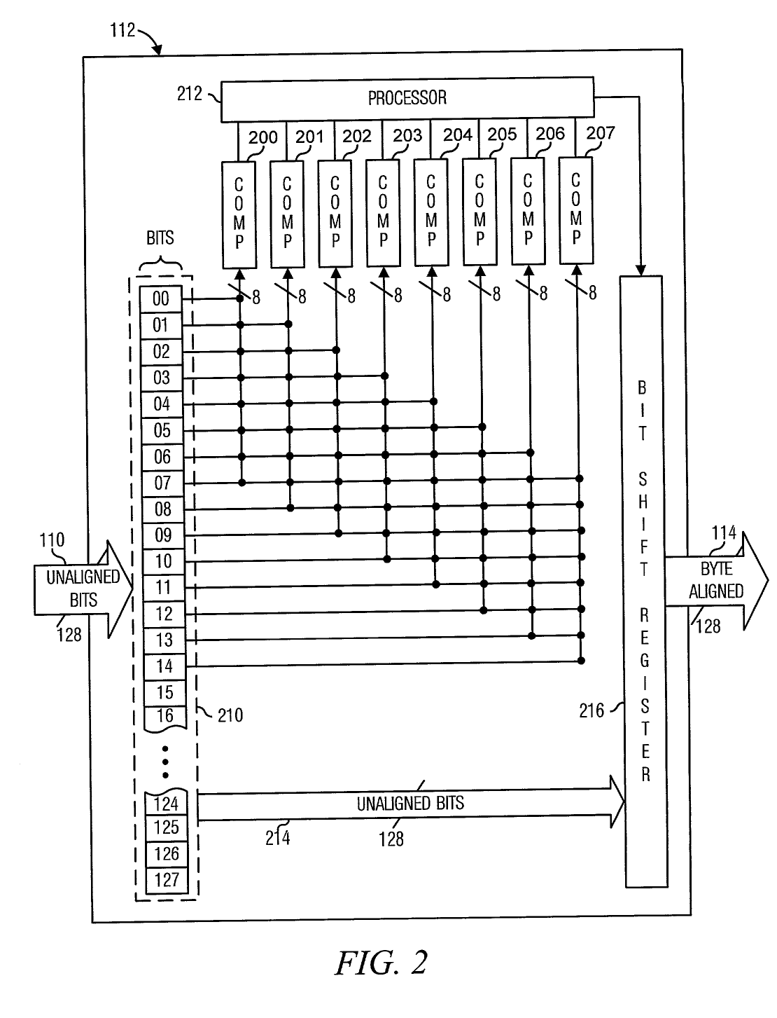

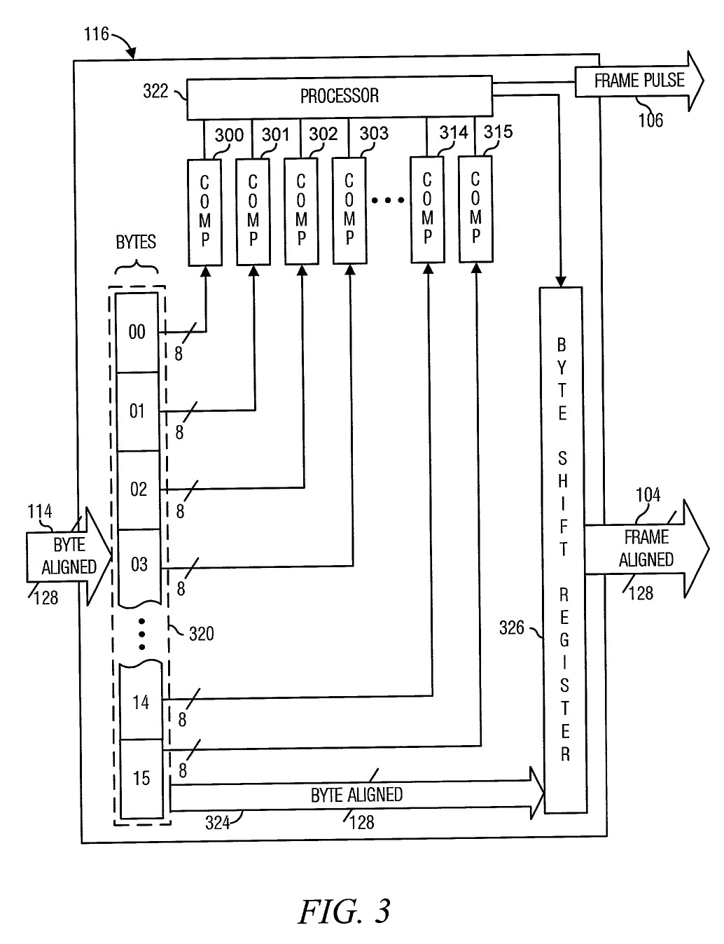

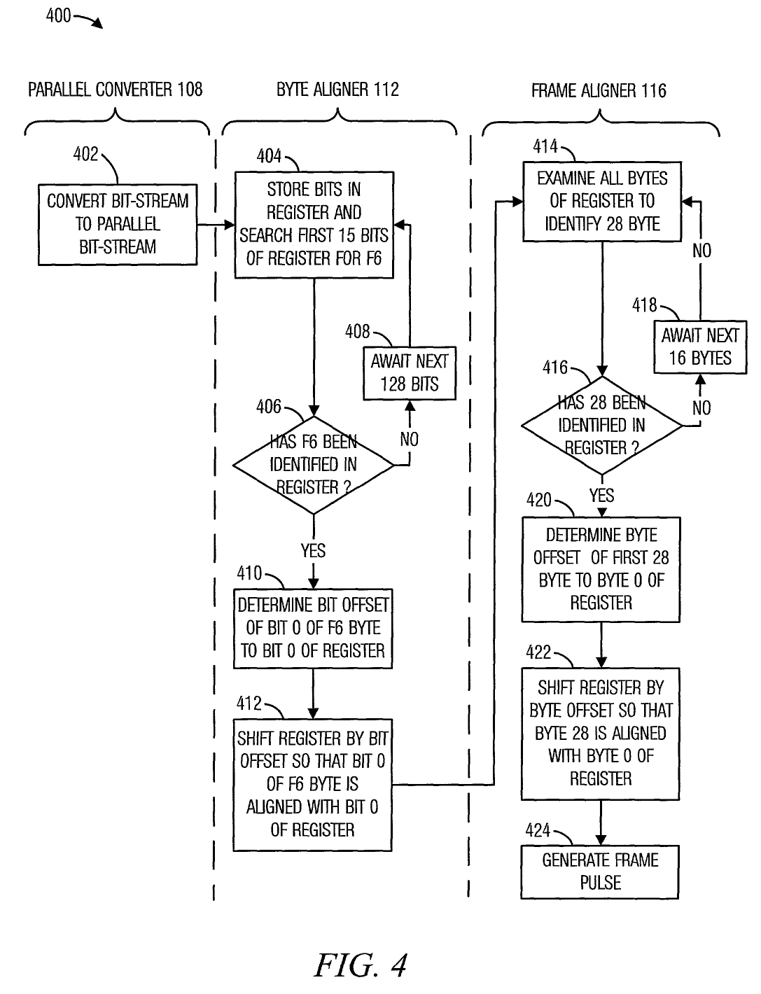

The converter 108 is connected for transmitting the converted bit stream via a 128 bit wide parallel bus 110 to a byte aligner 112. The byte aligner 112 is configured for receiving the parallel bit stream from the bus 110, and for shifting the bits so that the first bit (bit 0) of a byte is properly aligned with the bit 0 of the parallel bit stream, as discussed in further detail below with respect to FIGS. 2 and 4. The byte aligner 112 is further connected for transmitting a byte-aligned bit stream via a 128 bit wide, parallel bus 114 to a frame aligner 116. The frame aligner 116 is further configured for generating a frame-aligned bit stream onto a 128 bit wide parallel bus 104, and for generating a frame pulse onto a line 106, as discussed further below with respect to FIGS. 3 and 4.

FIG. 2 exemplifies one embodiment that may be utilized to implement the byte aligner 112 in accordance with principles of the present invention. Accordingly, the byte aligner 112 comprises a register 210 configured for receiving and storing 128 bits received in one clock cycle from the 128 bit parallel bit stream from the converter 102 via the bus 106. For purposes of illustration, the present invention is exemplified using a 128 bit register 210; however, the length of the register 210 may generally be any integral (greater than one) multiple of the number of bits in a word (e.g., byte) used in the bit stream, but less than or equal to the number of transition words repeated at the beginning of a frame. In accordance with the foregoing, the register 210 is configured for storing 128 bits in cells 00 through 127 of the register.

Preferably, the first 15 contiguous cells, i.e., cells 00-14, of the register 210 are connected for transferring a copy of the contents of eight selected cells at a time to at least one of eight byte comparators 200, 201, 202, 203, 204, 205, 206, and 207 (200-207), so that each comparator receives copies of the contents of eight cells. More specifically, as shown in FIG. 2, the comparator 200 receives a copy of the contents of bit cells 00-07, the comparator 201 receives copies of the contents of bit cells 01-08, the comparator 202 receives copies of the contents of bit cells 02-09, the comparator 203 receives copies of the contents of bit cells 03-10, the comparator 204 receives copies of the contents of bit cells 04-11, the comparator 205 receives copies of the contents of bit cells 05-12, the comparator 206 receives copies of the contents of bit cells 06-13, and the comparator 207 receives copies of the contents of bit cells 07-14. While the 15 bit cells 00-14 are shown as contiguous in FIG. 2, it is neither required that they be contiguous, nor that they begin with cell 00. Any cell may be replaced by another cell that is offset from it by an integral multiple of eight bits. For example, the comparator 201 may alternatively be connected for receiving the contents of the cells 9, 18, 27, 36, 45, 54, 63, and 72, and the comparator 202 may alternatively be connected for receiving the contents of the cells 1014, 23, 24, and 33.

Each comparator 200-207 is configured for comparing the bit pattern it receives, in ascending cell number order as depicted in FIG. 2, with the binary bit pattern 11110110 (“F6” in hexadecimal). If any comparator 200-207 identifies an F6 bit pattern, the identifying comparator generates a signal to a processor 212, which signal is recognized by the processor as indicating that the comparator has so identified an F6 bit pattern. For example, each comparator 200-207 may be configured to send a binary 1 to the processor 212 when it identifies an F6, and to send a binary 0 otherwise. The processor 212 may be any conventional processor suitable for performing the operations described herein and, while not shown, would typically include logic circuitry, memory, and a clock.

The processor 212 is configured so that, upon receipt of an indication that a respective comparator 200-207 has identified an F6 bit pattern, the processor 212 determines, and stores in memory (not shown), a bit shift offset representing the number of bits that the bit 0 of the identified F6 byte is offset from an integral number (e.g., zero in FIG. 2) of 8-bit bytes from the bit cell 00 of the register 210. For purposes of illustration, the offset for each comparator in FIG. 2 corresponds to the least significant digit of the reference numeral designating each respective comparator 200-207. For example, if the processor 212 receives an indication that the comparator 205 has identified an F6 bit pattern, then the processor 212 will store a “5” as the offset number in the memory. The processor 212 will also generate a copy of the stored offset number to the shift register 216. It will be appreciated that the offset number will be less than the number of bits constituting a byte (or word).

The bit shift register 216 is connected for receiving via a 128 bit wide bus 214, and storing, a copy of the contents of the cells 00-127 of the register 210. The shift register 216 then shifts the 128 bits it receives from the register 210 by the bit shift offset it received from the processor 212. Any bits lost during the shift are replaced by bits from the next 128 bits received from the bus 104 and converter 102 in a manner well-known in the art. For example, if the shift register 216 shifts the 128 bits by 2 bits, i.e., bits in cells 02-127 are shifted to cells 00-125, then bits in cells 00-01 of the next 128 bits are stored in cells 126-127 of the shift register 216 immediately following the shift operation. The shift register 216 is also connected for transmitting via the 128 bit wide bus 114 a copy of the shifted 128 bits of the register 216 to the frame aligner 116.

FIG. 3 exemplifies one embodiment that may be utilized to implement the frame aligner 116 in accordance with principles of the present invention. Accordingly, the frame aligner 116 comprises a register 320 configured for receiving and storing 16 bytes, each of which bytes comprise 8 bits, received in one clock cycle from the 128 bit parallel bit stream from the byte aligner 112 via the bus 114. For the purposes of illustration, and consistently with the byte aligner 112, the frame aligner of the present invention is exemplified using a 16 byte stream, though any number of bytes may be used. Accordingly, the register 320 is configured for storing 16 bytes in cells 00 through 15 of the register.

Each of 16 byte cells 00-15 of the register 320 is connected, via a respective 8 bit bus, for transferring a copy of the 8 bits of the respective cell to one of 16 corresponding single byte comparators (only six of which are shown) 300, 301, 302, 303, . . . 314, or 315 (300-315). More specifically, and as shown in FIG. 3, the comparator 300 receives a copy of the byte stored in the byte cell 00, the comparator 301 receives a copy of the byte stored in the byte cell 01, the comparator 302 receives a copy of the byte stored in the byte cell 02, the comparator 303 receives a copy of the byte stored in the byte cell 03, the comparator 314 receives a copy of the byte stored in the byte cell 14, and the comparator 315 receives a copy of the byte stored in the byte cell 15.

Each byte comparator 300-315 is configured for comparing the byte (i.e., eight bits) it receives with the hexadecimal value of “28” (i.e., a binary bit pattern of 00101000). If any one or more comparators 300-315 identify such a 28 byte, the one or more identifying comparators generate a signal to a processor 322 which is recognized by the processor as indicating that the respective comparator has so identified a 28 byte. For example, each comparator 300-315 may be configured to send a binary 1 to the processor 322 when it identifies a 28, and to send a binary 0 otherwise. If more than one comparator 300-315 identifies such a 28 byte, the processor 322 chooses the first 28 byte identified by the comparators 300-315. For example, if comparators 300-302 detect an F6 byte, and comparators 303-315 detect a 28 byte, then the processor 322 will use the signal from the comparator 303 for processing. The processor 322 may be any conventional processor suitable for performing the operations described herein and, while not shown, would typically include logic circuitry, memory, a clock, and a counter.

The processor 322 is configured so that, upon receipt of an indication that a respective comparator 300-315 has identified a 28 byte, the processor 322 determines, and stores in memory, a byte offset number representing the offset in bytes that the identified 28 byte is offset from the byte cell 00 of the register 320. For purposes of illustration, the offset number in FIG. 3 corresponds to the two least significant digits of the reference numeral designating each respective comparator 300-315. For example, if the processor 322 receives an indication that the comparator 303 has identified a 28 byte, then the processor 322 will store a “03” as the offset number in the memory. The processor 322 will also generate a copy of the stored offset number to the shift register 326.

The byte shift register 326 is connected for receiving via a 128 bit wide bus 324 a copy of the contents of the byte cells 00-15 of the register 320. The shift register 326 then shifts the 16 bytes it receives from the register 320 by the byte shift number it received from the processor 322. Any bytes lost during the shift are replaced by bytes from the next 16 bytes received from the byte aligner 108 and bus 110 in a manner well-known in the art. For example, if the shift register 326 shifts the 16 bytes by 2 bytes, i.e., bytes in cells 02-15 are shifted to cells 00-13, then bytes in cells 00-01 of the next 16 bytes are stored in cells 1415 of the shift register 326 immediately following the shift operation. The shift register 326 is also connected for transmitting via the 128 bit wide bus 104 a copy of the 16 bytes of the register 326 to downstream devices for which the bit stream is intended.

The processor 322 is still further configured for generating onto a line 106 a frame pulse identifying the beginning of a frame, by marking the point at which the bytes make a transition from F6 bytes to 28 bytes, so that all subsequent bytes in the bit stream of the frame may be identified. The processor 322 may alternatively adjust the frame pulse to identify, from the F6-28 transition, the point at which the first F6 byte is located. In a further alternative, the processor 322 may adjust the frame pulse to identify the first F6 or 28 byte in an external bit stream running from the line 104 in parallel to the framing system 100. Given the identification of the F6-28 transition in accordance with the present invention, it is considered that, upon a review of the present description of the invention, a person having ordinary skill in the art could configure the processor 322 to generate, and could utilize downstream, a frame pulse, and such will therefore not be discussed in further detail herein.

FIG. 4 depicts a flowchart 400 of control logic implemented by the framing system 100 for framing serial bits in accordance with the present invention. In step 402, the converter 108 converts the bit stream on the bus 102 to a parallel bit stream 128 bits wide, and transmits it to the byte aligner 108.

In step 404, the byte aligner 112 receives the 128 bits from the bit stream converter 108, and stores the bits in the register 210 and in the shift register 216. In step 406, a determination is made by the comparators 200-207 and processor 212 to determine whether an “F6” bit pattern is in the first fifteen bits, i.e., in the bits in cells 00-14. If, in step 406, it is not determined that an F6 bit pattern is in the first fifteen bits, then execution proceeds to step 408 to await the next clock cycle for the next 128 bits in the bit stream. Upon arrival of the next clock cycle, execution returns to step 404. If, in step 406, it is determined that an F6 has been located, i.e., that a comparator 200-207 has generated a signal to the processor 212 indicating that a F6 match has been found, then execution proceeds to step 410, wherein the processor 212 determines which comparator has generated the signal, to thereby determine, and store in memory, a bit shift offset of a bit 0 of the identified F6 byte to bit 0 (cell 00) of the register 210. In step 412, the processor 212 generates a signal to the bit shift register 216 instructing the shift register 216 to shift bits by the bit offset, and the shift register 216 shifts the bits accordingly, so that bit 0 of the F6 byte is aligned with the bit 0 of the register, thereby aligning the bytes with the register. Bits lost during the shift operation are replaced by advancing bits in a conventional manner from the next 128 bits in the bit stream. The shifted 128 bits are then transmitted on the bus 114 to the frame aligner 116, and execution proceeds to step 414.

In step 414, the frame aligner 116 receives the byte aligned 128 bits from the byte aligner 112, and stores the bits in the register 320 and the shift register 326. In step 416, the comparators 300-315 and processor 322 then examine the bits at a byte level to determine whether there is a “28” byte. If a 28 byte is not identified, then execution proceeds to step 418, wherein the next clock cycle is awaited. Upon arrival of the next clock cycle, execution returns to step 414. If in step 416, one or more comparators 300-315 do identify a 28 byte, then the one or more comparators generate a signal to the processor 322 indicating such identification, and execution proceeds to step 420.

In step 420, the processor 322 determines the byte offset of the identified 28 byte from byte 0 of the register 320 from knowing which comparator generated a signal to the processor indicating identification of the 28 byte. If more than one comparator generated such a signal, then the processor 322 uses the least byte offset that would be indicated from the two or more comparators. Alternatively, the processor 322 may use the byte offset which would be based on a byte located adjacent to an F6 byte. Upon determination of the byte offset, execution proceeds to step 422 in which the processor 322 generates a signal to the shift register 326 to shift bytes by the byte offset, until the 28 byte is aligned with byte 0 (cell 00) of the register 326. If bytes are lost during the shift, then bytes are advanced from the next 16 bytes in a conventional manner until the shift register is full. The shifted 16 bytes are then transmitted on the bus 114 to additional devices downstream from the frame aligner, and execution proceeds to step 424. In step 424, the processor 322 generates a frame pulse on to the line 106 to accompany the frame aligned bits on the bus 104. Generation and utilization of the frame pulse is considered to be well known to a person having ordinary skill in the art, based upon a reading of the present description, and, therefore, will be not discussed in further detail herein.

It is noted that subsequent bits transmitted through the framing system 100 are shifted in the shift register 216 by the same bit offset determined in step 410, and in the shift register 326 by the same byte offset determined in step 420. Conventional phase lock shifting is also conducted, as well as checks of the F6-28 transition in subsequent frames to ensure that the system stays “in frame.”

By the use of the present invention shown in FIGS. 1-4, expensive, custom, framing systems may be replaced by an economical, non-custom device using readily-available, off-the-shelf components.

It is understood that the present invention may take many forms and embodiments. Accordingly, several variations may be made in the foregoing without departing from the spirit or the scope of the invention. For example, the registers 216 and 320 may be shared. The system may be adapted for bit stream narrower or wider than 128 bits, such as may be desirable with bit rates exceeding 10 GHz, such as 40 GHz which is supported by OC 768. In another variation, in step 414, the comparators 300-315 may be configured to examiner bytes to ensure that all bytes subsequent to the identification of an F8 byte in step 406 and prior to the identification of a 28 byte in step 416 are F6 bytes.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A method for locating and aligning to framing bits comprising:
examining fifteen bits of a parallel bit stream to identify a first repeating byte;
upon identification of a first repeating byte, determining a bit offset of the byte from a bit zero of the parallel bit stream;
shifting the bits in the parallel bit stream by the determined bit offset to generate a byte aligned parallel bit stream;
examining each byte of the byte aligned parallel bit stream to identify a second repeating byte;
upon identification of a second repeating byte, determining a byte offset of the second repeating byte from a byte zero of the parallel bit stream;
shifting the bytes in the parallel bit stream by the determined byte offset to generate a frame aligned parallel bit stream;
transmitting the frame aligned parallel bit stream; and
generating a frame pulse to accompany the frame aligned parallel bit stream.

2. The method of claim 1 wherein the fifteen bits of a parallel bit stream are the first fifteen bits of a parallel bit stream.

3. The method of claim 1 wherein the first repeating byte is a hexadecimal F6, and the second repeating byte is a hexadecimal 28.

4. A system for locating and aligning to framing bits comprising:
means for examining fifteen bits of a parallel bit stream to identify a first repeating byte;
means for upon identification of a first repeating byte, determining a bit offset of the byte from a bit zero of the parallel bit stream;
means for shifting the bits in the parallel bit stream by the determined bit offset to generate a byte aligned parallel bit stream;
means for examining each byte of the byte aligned parallel bit stream to identify a second repeating byte;
means, upon identification of a second repeating byte, for determining a byte offset of the second repeating byte from a byte zero of the parallel bit stream;
means for shifting the bytes in the parallel bit stream by the determined byte offset to generate a frame aligned parallel bit stream;
means for transmitting the frame aligned parallel bit stream; and
means for generating a frame pulse to accompany the frame aligned parallel bit stream.

5. The method of claim 4 wherein the fifteen bits of a parallel bit stream are the first fifteen bits of a parallel bit stream.

6. The method of claim 4 wherein the first repeating byte is a hexadecimal F6, and the second repeating byte is a hexadecimal 28.
